(19) United States
(12) Patent Application Publication
(10) Pub. No.: US 2024/0084195 A1
(43) Pub. Date: Mar. 14, 2024

(54) COMPOSITIONS AND METHODS FOR IMPROVING SOIL CONDITION

(71) Applicant: Kannar Earth Science, Ltd., Lawrenceville, GA (US)

(72) Inventors: Samuel L. Cloete, Suwanee, GA (US); Heather Lewis, Duluth, GA (US)

(21) Appl. No.: 18/228,280

(22) Filed: Jul. 31, 2023

Related U.S. Application Data
(60) Provisional application No. 63/375,294, filed on Sep. 12, 2022.

(51) Int. Cl. C09K 17/32; A01G 24/35; A01G 24/42; A01G 24/48

(52) U.S. Cl. CPC C09K 17/32; A01G 24/35; A01G 24/42; A01G 24/48

(57) ABSTRACT

Dry compositions for conditioning soil are provided that enhance plant growth by creating beneficial soil environments. The dry compositions include a superabsorbent polymer and a cellulosic fiber that includes at least one of hydroxyethylcellulose and methyl cellulose. In addition, methods are provided for improving soil condition by applying the compositions to soil. The compositions have improved handling properties, including flowability in commercial applications, relative to superabsorbent polymers alone. Surprisingly, the compositions can improve soil moisture retention, increase the uptake of nutrients by plants, reduce leaching of nutrients, pesticides, and microbes, and improve seedling ability to break through soil crusts as well or better than superabsorbent polymers alone.

### CROSS-REFERENCE TO RELATED APPLICATIONS

This application claims priority to U.S. Provisional Patent Application No. 63/375,294, filed on Sep. 12, 2022, which is incorporated by reference herein in its entirety.

### BACKGROUND

Plant growth is dependent on the soil environment and conditions. Indeed, many amendments to soil are commonly made to create beneficial soil environments that improve growing conditions. To improve water retention of soil, superabsorbent polymers have been used as soil conditioners to keep a constant supply of moisture available to the soil, germinating seeds, seedlings, and plants throughout the growing season. However, limitations arising from the water absorbing properties of such superabsorbent polymers severely limit their usefulness in agricultural contexts. Superabsorbent polymers are often so hydrophilic that they attract moisture from the air and turn from a dry granule into an expanded gel or paste. This frequently results in fouling and clogging of the confined channels and narrow openings in equipment used in the dry bulk application processes of modern agriculture. This issue has severely limited the usefulness of these products in agriculture. Accordingly, there remains an unmet need for superabsorbent polymer compositions with fewer limitations on their usefulness, but which retain their water absorbing properties when applied to soil to provide more beneficial soil environments for plant growth. The present disclosure provides such superabsorbent polymer compositions and methods for their use.

### SUMMARY

In one aspect of the present invention, a dry composition is provided for use as a soil conditioner that includes a superabsorbent polymer and a cellulosic fiber comprising at least one of hydroxyethylcellulose and methyl cellulose.

In various embodiments, the superabsorbent polymer is one or more of a starch-based polymer, starch-g-poly(2-propenaminde-co-2-propenoic acid), starch grafted-2-propenoic acid-2 crosslinked polymer, xanthan gum, guar gum, hydroxyethylcarboxymethylcellulose, carboxymethylcellulose, polyacrylamides, zeolite hyaluronic acid, humic acid, chitin/chitosan polymers, volcanic earth and ash, kelp, or sea weed.

In one embodiment, the composition comprises starch grafted-2-propenoic acid-2 crosslinked polymer superabsorbent polymer and hydroxyethylcellulose cellulosic fiber.

In another embodiment, the composition comprises starch-g-poly(2-propenaminde-co-2-propenoic acid) superabsorbent polymer and hydroxyethylcellulose cellulosic fiber.

In some embodiments, the superabsorbent polymer and the cellulosic fiber are not covalently bonded.

The compositions of the present disclosure can further comprise one or more of a nutrient, plant growth promoter, microbial agent, pesticide, antioxidant, fertilizer, or biostimulants for benefiting one or both of plant growth and health. The nutrient, plant growth promoter, microbial agent, pesticide, antioxidant, fertilizer, or biostimulant can include one or more of Bacillus licheniformis strain NRRL B-23318 (K-357) or potassium humate.

The ratio of the superabsorbent polymer to the cellulosic fiber in the compositions of the present disclosure can range from about 99:1 to about 75:25, about 98:2 to about 75:25, about 97:3 to about 75:25, about 96:4 to about 75:25, about 95:5 to about 75:25, about 94:6 to about 75:25, or about 90:10 to about 75:25. In one instance, the ratio of the superabsorbent polymer to the cellulosic fiber ranges from about 97:3 to about 25:75.

The compositions of the present disclosure can be formulated as granules, flakes, powders, or prills, or combinations thereof.

In another aspect of the invention, a method is provided for improving the condition of soil, the method including applying to soil a composition of the present disclosure that includes a superabsorbent polymer and at least one of hydroxyethylcellulose or methyl cellulose.

In some aspects of the method, the compositions of the present disclosure can be applied to the soil by depositing the composition on top of soil, mixing the composition with soil or applying the composition deep into soil. The composition can be mixed with soil at a rate of about 0.5 to about 4 pounds per acre or about 1 to about 3 pounds per acre. In other instances, the composition can be applied deep into soil at a rate ranging from about 8 to about 12 pounds per acre.

### BRIEF DESCRIPTION OF THE DRAWINGS

The features and advantages of the present invention will be more clearly understood from the following description taken in conjunction with the accompanying drawings. The accompanying Figures are provided by way of illustration and not by way of limitation. The foregoing aspects and other features of the disclosure are explained in the following description, taken in connection with the accompanying example figures (also “FIG.”) relating to one or more embodiments.

FIG. 1 is a schematic outline of an experimental design comparing superabsorbent polymer starch-g-poly(2-propenaminde-co-2-propenoic acid (“Zeba”) mixed with sand or dry hydroxyethylcellulose (“HEC”) mixed with sand to superabsorbent polymer blend including Zeba and HEC mixed with sand according to one or more embodiments of the invention.

FIG. 2 is a schematic outline of an experimental design comparing superabsorbent polymer starch grafted-2-propenoic acid-2 crosslinked polymer (“MJJ-A-2000”) mixed with sand or dry hydroxyethylcellulose (“HEC”) mixed with sand to a superabsorbent polymer blend including MJJ-A-2000 and HEC mixed with sand according to one or more embodiments of the invention.

FIG. 3 is a schematic outline of an experimental design to test for dissolved nutrients in liquid leached from containers with sand or sand plus a blend of superabsorbent polymer starch-g-poly(2-propenaminde-co-2-propenoic acid (“Zeba”) and dry hydroxyethylcellulose (“HEC”) according to one or more embodiments of the invention.

FIG. 4 is a schematic outline of an experimental design to test for dissolved nutrients in liquid leached from containers with sand or sand plus a blend of a superabsorbent polymer that is a starch grafted-2-propenoic acid-2 crosslinked polymer (“MJJ-A-2000”) and dry hydroxyethylcellulose (“HEC”) according to one or more embodiments of the invention.

FIG. 5A is a series of photographs of pots taken 3 days after sowing 10 canola seedlings per pot and growing in greenhouse conditions, where the pots contain clay soil placed on top of potting soil alone (Soil alone).

FIG. 5B is a series of photographs of pots taken 3 days after sowing 10 canola seedlings per pot and growing in greenhouse conditions, where the pots contain clay soil placed on top of potting soil mixed with a blend of superabsorbent polymer MJJ-A-2000 and HEC (Soil+MJJ-A-2000 & HEC Blend) according to one or more embodiments of the invention.

FIG. 5C is a series of photographs of pots taken 3 days after sowing 10 canola seedlings per pot and growing in greenhouse conditions, where the pots contain clay soil placed on top of potting soil mixed with a blend of superabsorbent polymer Zeba and HEC (Soil+Zeba & HEC Blend) according to one or more embodiments of the invention.

FIG. 6 is a bar graph illustrating potassium uptake for peanut plants after 21 days of growth showing a significant increase of potassium uptake (22.4%) by the plants grown with the superabsorbent polymer blend (Soil+Fertilizer+Zeba & HEC blend) as compared to the plants grown without the supplement (Soil+Fertilizer) according to one or more embodiments of the invention.

FIG. 7 is a graph illustrating the weight change of pots containing young tomato plants over the course of two weeks of drought conditions, where the pots contained soil, soil+fertilizer ixed, soil+fertilizer+Zeba & HEC blend all mixed, or soil+fertilizer mixed+Zeba & HEC blend added on top according to one or more embodiments of the invention.

FIG. 8 shows photographs of tomato leaves after two weeks of growth in the greenhouse without water from the experiment described in FIG. 7, where the leaf on the left grown in the soil+fertilizer+Zeba & HEC blend all mixed entry is a greener and leathery leaf and the leaf on the right grown in the soil+fertilizer mixed without superabsorbent polymer blend is a smaller, pale green and thin leaf with dry tip tissue.

### DETAILED DESCRIPTION

To promote an understanding of the principles of the present disclosure, reference will now be made to preferred embodiments and specific language will be used to describe the same. It will nevertheless be understood that no limitation of the scope of the disclosure is thereby intended, such alteration and further modifications of the disclosure as illustrated herein, being contemplated as would normally occur to one skilled in the art to which the disclosure relates.

Unless otherwise indicated, technical and scientific terms used herein have the same meaning as commonly understood by those of ordinary skill in the art to which this disclosure belongs.

Following long-standing patent law convention, the terms “a,” “an,” and “the” refer to “one or more” when used in this application, including the claims. Thus, for example, reference to “a dry composition” includes a plurality of dry compositions, unless the context clearly is to the contrary, and so forth.

Throughout this specification and the claims, the terms “comprise,” “comprises,” and “comprising” are used in a non-exclusive sense, except where the context requires otherwise. Likewise, the terms “having” and “including” and their grammatical variants are intended to be non-limiting, such that recitation of items in a list is not to the exclusion of other like items that can be substituted or added to the listed items.

For the purposes of this specification and claims, the term “about” when used in connection with one or more numbers or numerical ranges, should be understood to refer to all such numbers, including all numbers in a range and modifies that range by extending the boundaries above and below the numerical values set forth. The recitation of numerical ranges by endpoints includes all numbers, e.g., whole integers, including fractions thereof, subsumed within that range (for example, the recitation of 1 to 5 includes 1, 2, 3, 4, and 5, as well as fractions thereof, e.g., 1.5, 2.25, 3.75, 4.1, and the like) and any range within that range. In addition, as used herein, the term “about”, when referring to a value can encompass variations of, in some embodiments +/−20%, in some embodiments +/−10%, in some embodiments +/−5%, in some embodiments +/−1%, in some embodiments +/−0.5%, and in some embodiments +/−0.1%, from the specified amount, as such variations are appropriate in the disclosed compositions and methods. Where particular values are described in the application and claims, unless otherwise stated, the term “about” meaning within an acceptable error range for the particular value should be assumed.

In various embodiments, the present disclosure provides dry compositions for conditioning soil that can enhance plant growth and health by creating beneficial soil environments. The dry compositions provided herein include a superabsorbent polymer and a cellulosic polymer including at least one of hydroxyethylcellulose and methyl cellulose. The compositions of the present disclosure are referred to herein interchangeably as “compositions” and “superabsorbent polymer blends”. The compositions of the present disclosure can be a blend of the superabsorbent polymer and the cellulosic fiber where the superabsorbent polymer and the cellulosic fiber are not covalently bonded. The compositions of the present disclosure provide advantages including improving soil moisture retention, reducing nutrient, pesticide, and microbial leaching from the soil, increasing the ability of seedlings to break through soil crust, enhancing nutrient uptake by plants, and improving crop yield. Unexpectedly, the polymer blends of the present disclosure are shown in the Examples provided herein have equal or greater beneficial properties than when superabsorbent polymers are used alone as a soil conditioner. Another advantage of the superabsorbent polymer blends of the present disclosure is their improved handling properties relative to superabsorbent polymers alone. For example, the superabsorbent polymer blends of the present disclosure have improved flowability in commercial applications, like dry bulk application and planting processes relative to superabsorbent polymers alone.

The superabsorbent polymers of the present disclosure can include one or more of a starch-based polymer, starch-g-poly(2-propenaminde-co-2-propenoic acid), starch grafted-2-Propenoic Acid-2 crosslinked polymer, xanthan gum, guar gum, hydroxyethylcarboxymethylcellulose, carboxymethylcellulose, polyacrylamides, zeolite hyaluronic acid, humic acid, chitin/chitosan polymers, volcanic earth and ash, kelp, or sea weed. In some instances, the compositions or superabsorbent polymer blends of the present disclosure can further comprise one or a combination of a nutrient, plant growth promoter, microbial agent, pesticide, antioxidant, fertilizer, or biostimulant for benefiting one or both of plant growth and health. The nutrient, plant growth promoter, microbial agents, pesticides, antioxidants, fertilizers, or biostimulants can include one or more of Bacillus licheniformis strain NRRL B-23318 (K-357) or potassium humate.

In one or more aspects, the compositions of the present disclosure, when added to the soil create desirable and beneficial soil conditions for plant growth. Indeed, the compositions provided herein can create a more beneficial soil environment for crops by increasing the efficacy or uptake of pesticides. For example, the compositions can aid with the uptake of a thiamethoxam or 0,0-diethyl S-[(ethylthio) methyl] phosphorodithioate pesticide compound. Without being limited to any particular mechanism of action, the compositions may aid the uptake of the pesticide by creating a more moisture rich environment in soil in which the pesticide is present. Moreover, the compositions can provide a beneficial soil environment by being compatible with microbes, micronutrients, nutrients, antioxidants, biostimulants, pesticides, fertilizers, and other crop establishment tools. In certain aspects, the compositions can improve water retention, improve nutrient uptake, and reduce leaching of nutrients, pesticides, and/or microbes. In some embodiments, the additives for benefiting plant growth and health are present in the soil rather than being included in the composition or in addition to being included in the composition. The superabsorbent polymer blends of the present disclosure can improve the efficacy of the additives through one or both of improved uptake of the additive by the plant and reduced leaching of the additive from the soil.

Experiments describing the ability of the compositions of the present disclosure to increase soil moisture retention, reduce nutrient, pesticide, and microbial leaching from soil, increase the ability of seedlings to break through soil crust, increase nutrient uptake, improve plant growth and health in drought conditions, and increase plant yield are described in Examples 1-8. The experiments involve use of a superabsorbent polymer alone or as part of a blend with dry hydroxyethylcellulose. The superabsorbent polymers used in Examples 1-8 are starch-g-poly (2-propenamide-co-2-propenoic acid) sold as “ZEBA” by UPL NA Inc and referred to herein as “Zeba”, or a superabsorbent polymer that is a starch grafted-2-propenoic acid-2 crosslinked polymer referred to herein as “MJJ-A-2000”. The dry hydroxyethylcellulose is referred to herein as “HEC”. Specifically, an experiment demonstrating improved water retention of soil treated with a composition of the present disclosure is described in Example 1. An experiment demonstrating reduced nutrient leaching from soil treated with a composition of the present disclosure is described in Example 2. An experiment demonstrating reduced pesticide leaching from soil treated with a composition of the present disclosure is described in Example 3. An experiment demonstrating reduced leaching of microbes from soil treated with a composition of the present disclosure is described in Example 4. An experiment demonstrating increased ability for seedlings to break through soil crusts in soil treated with a composition of the present disclosure is described in Example 5. An experiment demonstrating enhanced nutrient uptake by plants grown in soil treated with a composition of the present disclosure is described in Example 6. An experiment that demonstrates improved plant growth in drought conditions in soil treated with a composition of the present disclosure is described in Example 7. An experiment demonstrating improved yield in a field trial when a composition of the present disclosure is applied to the soil is described in Example 8.

In one embodiment, the composition of the present disclosure includes starch grafted-2-propenoic acid-2 crosslinked polymer superabsorbent polymer and hydroxyethylcellulose cellulosic fiber.

In another embodiment, the composition of the present disclosure includes starch-g-poly(2-propenaminde-co-2-propenoic acid) superabsorbent polymer and hydroxyethylcellulose cellulosic fiber.

The ratio of the superabsorbent polymer to the cellulosic fiber in the compositions of the present disclosure can range from about 99:1 to about 75:25, about 98:2 to about 75:25, about 97:3 to about 75:25, about 96:4 to about 75:25, about 95:5 to about 75:25, about 94:6 to about 75:25, or about 90:10 to about 75:25. In one instance, the ratio of the superabsorbent polymer to the cellulosic fiber ranges from about 97:3 to about 25:75.

In one instance, the composition includes starch grafted-2-propenoic acid-2 crosslinked polymer superabsorbent polymer and hydroxyethylcellulose cellulosic fiber at a ratio ranging from about 97:3 to about 25:75.

In another instance, the composition includes starch-g-poly(2-propenaminde-co-2-propenoic acid) superabsorbent polymer and hydroxyethylcellulose cellulosic fiber at a ratio ranging from about 97:3 to about 25:75.

The compositions of the present disclosure can be formulated as granules, flakes, powders, or prills, or combinations thereof.

In another aspect, the present invention provides a method for improving soil conditions by applying to the soil a composition of the present disclosure that includes a superabsorbent polymer and at least one of hydroxyethylcellulose or methyl cellulose. The compositions of the present disclosure can be applied to the soil by depositing the composition on top of soil, mixing the composition with soil or applying the composition deep into soil. The composition can be mixed with soil at a rate of about 0.5 to about 4 pounds per acre or about 1 to about 3 pounds per acre. In other instances, the composition can be applied deep into soil at a rate ranging from about 8 to about 12 pounds per acre.

In additional aspects, a method is provided for preparing the soil conditioning compositions of the present disclosure by mixing a superabsorbent polymer with at least one of hydroxyethylcellulose or methyl cellulose. The method for preparing the soil conditioning composition can further include mixing one or more additives, such as nutrients, plant growth promoters, microbial agents, pesticides, antioxidants, fertilizers, and biostimulants, with the superabsorbent polymer and one of hydroxyethylcellulose or methyl cellulose.

The present invention will be described in more detail below through examples, but these examples are not intended to limit the present disclosure.

### EXAMPLES

### Example 1

### Improved Water Retention

An experiment was performed in which the water retention capabilities of soil itself and soil with various combinations of added dry materials were compared. There are three types of soil. They are sand, silt, and clay. Of these types of soil, sand has a high rate of leaching. For this reason, sand was used for these experiments.

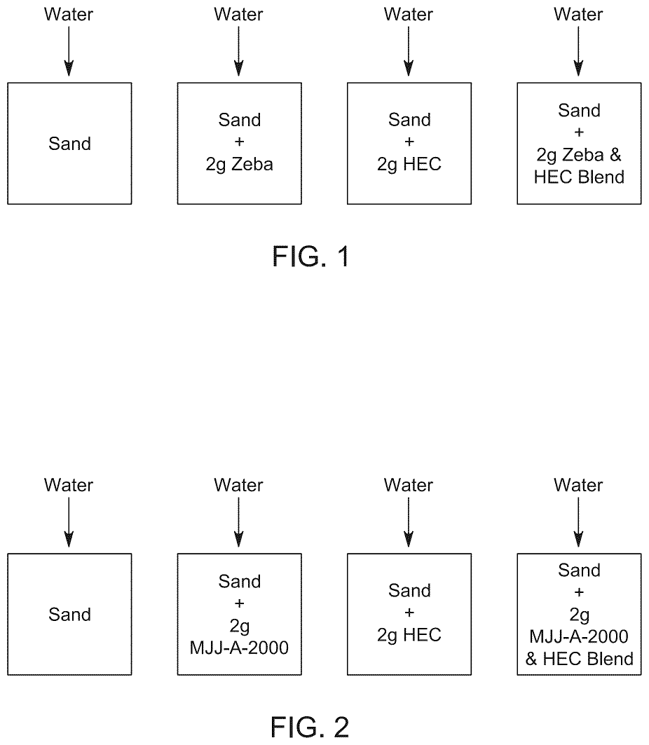

The same overall weight of dry materials (i.e., 45 gram) was added to each container. For the entries that included material other than sand, the weight of sand was reduced by the amount of the additional dry materials included. Water was then added to the first container until the first drop of water is observed. The water was added 1 mL at a time with 1 minute in between to allow the water to attempt to penetrate the blend. The amount of water needed for the first drop of water to leech out was noted for each entry. The entries are shown below and also in FIG. 1:
Sand;
Sand+2 g starch-g-poly(2-propenaminde-co-2-propenoic acid) (“Zeba”);
Sand+2 g Dry Hydroxyethylcellulose (“HEC”); and
Sand+2 g Zeba and HEC blend (ratio of Zeba to HEC equal to 96.8:3.2).

Zeba used in the experiment was from UPL NA Inc. The more water that is needed before the first drop is observed, the more moisture retention is occurring. The results are shown in Table 1 below.

TABLE 1
First Drop of Water with Superabsorbent Polymer Zeba Blend

| | Rep 1 | Rep 2 | Rep 3 | Rep 4 | Rep 5 |
|---|---|---|---|---|---|
| Sand | 12 mL | 12 mL | 12 mL | 12 mL | 12 mL |
| Sand + Zeba | 16 mL | 16 mL | 16 mL | 15 mL | 16 mL |
| Sand + HEC | 13 mL | 13 mL | 14 mL | 13 mL | 13 mL |
| Sand + Zeba & | 21 mL | 21 mL | 20 mL | 21 mL | 21 mL |
| HEC Blend | | | | | |

The weight of the empty container was 10.80 g. The weight of the dry materials including the sand in the container for each entry was 45 g. The weight of the empty container plus the dry materials for each entry was 55.80 g. For the entries that contained Sand and Zeba, 2 g of Zeba was blended with the sand. For the entries that utilized Sand and Dry Hydroxyethylcellulose (“HEC”), 2 g of HEC was blended with the sand. For the entries that utilized sand with Zeba and HEC, the Zeba and HEC were mixed together into a blend and then 2 g of this mixture was blended with the Sand. The Zeba and HEC were mixed together to create the blend at a ratio of 96.8:3.2 Zeba to HEC, respectively.

It took 12 mL of water before there was leaching observed in the entry with just sand. It took between 15 mL and 16 mL of water before there was leaching observed in the entry with sand and Zeba. It took between 13 mL and 14 mL of water before there was leaching observed in the entry with sand and HEC. It took between 20 and 21 mL of water before there was leaching observed in the entry with sand and the combination of Zeba and HEC. The sand by itself performed the worst. The entry that added Zeba as well as the entry that added HEC performed better than the entry with just sand, but did not perform as well as the entry with the combination of Zeba and HEC added to the sand. This shows that the Zeba and the HEC both aid in moisture retention and inclusion of the HEC does not inhibit the ability for moisture retention. It is also evident that the combination of the Zeba and HEC is superior with regards to moisture retention.

The experiment was replicated with another starch-based superabsorbent polymer that is starch grafted-2-propenoic acid-2 crosslinked polymer referred to as “MJJ-A-2000”. This experiment was performed the same as described above for superabsorbent polymer Zeba using the same ratios and amounts of the components except that MJJ-A-2000 was substituted for Zeba. The entries are shown below and also in FIG. 2:
Sand;
Sand+MJJ-A-2000;
Sand+HEC; and
Sand+MJJ-A-2000 and HEC blend (ratio of MJJ-A-2000 to HEC equal to 96.8:3.2).

The results are shown in Table 2 below.

TABLE 2
First Drop of Water with Superabsorbent
Polymer MJJ-A-2000 Blend

| | Rep 1 | Rep 2 | Rep 3 | Rep 4 | Rep 5 |
|---|---|---|---|---|---|
| Sand | 12 mL | 12 mL | 12 mL | 12 mL | 12 mL |
| Sand + MJJ-A-2000 | 16 mL | 15 mL | 16 mL | 16 mL | 16 mL |
| Sand + HEC | 13 mL | 13 mL | 14 mL | 13 mL | 13 mL |
| Sand + MJJ-A-2000 & | 21 mL | 22 mL | 21 mL | 21 mL | 21 mL |
| HEC Blend | | | | | |

For the entries that utilized Sand and HEC, 2 g of HEC was blended with the sand. For the entries that contained Sand and MJJ-A-2000, 2 g of MJJ-A-2000 was added to the bottom of the container. The sand was then added to the top of the container. This was because the moisture retention capabilities of the MJJ-A-2000 allowed for the polymer to expand too far outside of the container if the MJJ-A-2000 was blended with the sand. For the entries that utilized sand with MJJ-A-2000 and HEC, the MJJ-A-2000 and HEC were mixed together at a ratio of 96.8 MJJ-A-2000 to 3.2 HEC and then 2 g of this mixture was added to the bottom of the container. Sand was then added onto the top of this mixture.

It took 12 mL of water before there was leaching observed in the entry with just sand. It took between 15 and 16 mL of water before there was leaching observed in the entry with sand and MJJ-A-2000. It took between 13 and 14 mL of water before there was leaching observed in the entry with sand and HEC. It took between 21 and 22 mL of water before there was leaching observed in the entry with sand and the combination of MJJ-A-2000 and HEC. The sand by itself performed the worst. The entry that added MJJ-A-2000 as well as the entry that added HEC performed better than the entry with just sand but did not perform as well as the entry with the combination of MJJ-A-2000 and HEC added to the sand. This shows that HEC in addition to MJJ-A-2000 aids in moisture retention and does not inhibit the ability for moisture retention as could have been expected. It is also evident that the combination of the MJJ-A-2000 and HEC is superior with regard to moisture retention.

Using the observations from the experiments described above, the moisture retention capabilities of the superabsorbent polymer blends were then tested further by looking at the weight of water retained at the start of the experiment and after 1 hour and 24 hours. The entries were the same as described above and illustrated in FIG. 1. The same overall weight of dry materials was added to each container. Water is then added until leaching is observed in the container. The amount of water was determined by the part of the experiment in which the amount of water needed prior to the first drop of water leaching out was observed. Each entry in this part of the experiment had 21 mL of water added. Thereafter, the weights of the containers are taken to see how much water is absorbed. The results are shown in Table 3 below.

TABLE 3
Weights of Water Retention Experiment Containers
with Superabsorbent Polymer Zeba Blend

| | Starting | 1 Hour | 24 Hours |
|---|---|---|---|
| Sand | 66 g | 56.1 g | 55.9 g |
| Sand + Zeba | 66 g | 62.2 g | 62.1 g |
| Sand + HEC | 66 g | 62.9 g | 58.3 g |
| Sand + Zeba & HEC Blend | 66 g | 67.6 g | 64.1 g |

The weight of the empty container was 10.80 g. The weight of the dry materials including the sand in the container for each entry was 45 g. The weight of the empty container plus the dry materials for each entry was 55.80 g. The weight of the water was 21 g (21 mL). The weight of the dry ingredients plus the water for each entry was 66 g. The weight of the empty container plus the dry and wet ingredients was 76.80 g. The weight of the wet and dry ingredients was utilized as the starting weight.

For the entries that contained Sand and Zeba, 2 g of Zeba was blended with the sand. For the entries that utilized Sand and HEC, 2 g of HEC was blended with the sand. For the entries that utilized sand with Zeba and HEC, the Zeba and HEC were mixed together and then 2 g of this mixture was blended with the Sand.

The sand by itself performed the worst. The entry that added Zeba as well as the entry that added HEC performed better than the entry with just sand, but did not perform as well as the entry with the combination of Zeba and HEC added to the sand. It was noted that the sample that was a blend of Sand and HEC had some water stay at the top of the container and was not absorbed into the sand. This shows that the Zeba and the HEC both aid in moisture retention and inclusion of HEC does not inhibit the ability for moisture retention by the superabsorbent polymer as could have been expected. It is also evident that the combination of the Zeba and HEC is superior with regards to moisture retention relative to Zeba alone.

The experiment was also performed with the superabsorbent polymer MJJJ-A-2000 as described above and shown in FIG. 2. The results are shown in Table 4 below.

TABLE 4
Weights of Water Retention Experiment Containers
with Superabsorbent Polymer MJJ-A-2000 Blend

| | Starting | 1 Hour | 24 Hours |
|---|---|---|---|
| Sand | 66 g | 56.1 g | 55.9 g |
| Sand + MJJ-A-2000 | 66 g | 69.1 g | 65.6 g |
| Sand + HEC | 66 g | 62.9 g | 58.3 g |
| Sand + MJJ-A-2000 & HEC Blend | 66 g | 68.3 g | 65.7 g |

The weight of the empty container was 10.80 g. The weight of the dry materials including the sand in the container for each entry was 45 g. The weight of the empty container plus the dry materials for each entry was 55.80 g. The weight of the water was 21 g (21 mL). The weight of the dry ingredients plus the water for each entry was 66 g. The weight of the empty container plus the dry and wet ingredients was 76.80 g. The weight of the wet and dry ingredients was utilized as the starting weight.

The sand by itself performed the worst. The entry that added MJJ-A-2000 as well as the entry that added HEC performed better than the entry with just sand, but did not perform as well as the entry with the combination of MJJ-A-2000 and HEC added to the sand. This shows that the MJJ-A-2000 and the HEC both aid in moisture retention and inclusion of HEC does not inhibit the ability for moisture retention as could have been predicted.

Another experiment was performed to determine the effective range of the ratio of superabsorbent polymer to HEC. In the experiment, the superabsorbent polymer used was MJJ-A-2000. The entries for this experiment were as follows:
Entry 1=100% MJJ-A-2000;
Entry 2=99.5% MJJ-A-2000+0.5% HEC
Entry 3=99% MJJ-A-2000+1% HEC;
Entry 4=90% MJJ-A-2000+10% HEC;
Entry 5=75% MJJ-A-2000+25% HEC;
Entry 6=50% MJJ-A-2000+50% HEC; and
Entry 7=25% MJJ-A-2000+75% HEC.

In the experiment, 0.5 g of each entry was put into its own clean, dry container. 10 mL of water was added to each container. The results were as follows:
Entries 1-5 absorbed the water in under a minute.
Entry 6 absorbed the water in about 4 minutes.
Entry 7 absorbed the water in about 6 minutes.

An additional 10 mL of water was added to each container. The results were as follows:
Entries 1-5 absorbed the water in under a minute.
Entry 6 absorbed the water in about 2 minutes.
Entry 7 had not fully absorbed the water even after 10 minutes.

An additional 20 mL of water was added to each container. The results were as follows:
Entries 1-4 absorbed the water in under a minute.
Entry 5 absorbed the water in about 2.5 minutes
Entry 6 absorbed the water in about 7 minutes.
Entry 7 had not fully absorbed the water even after 10 minutes.

An additional 50 mL of water was added to each container. The results were as follows:
Entries 1-4 absorbed the water in under a minute.
Entry 5 absorbed the water in about 6 minutes
Entry 6 absorbed most of the water by the end of 3 days, but it did not appear to be fully absorbed.
Entry 7 had not fully absorbed the water even after 3 days.

The results of this experiment show that the capability of the superabsorbent polymer to retain water was not significantly inhibited by the addition of HEC when the ratio was between 0.5% and 25%. At these ratios, the blend was able to continue to absorb water easily. When the blend was 50% superabsorbent polymer to 50% HEC, the blend retained its ability to hold water, but did so at a slower pace than the entries that utilized HEC. Additionally, the amount of water able to be absorbed was lower than the entries that utilized less of the HEC. Adjusting the ratio of the superabsorbent polymer to HEC further than 50% to incorporate less superabsorbent polymer and more HEC showed signs of significantly slowing town the capability of the blend to absorb water as well as decreasing the amount of water that could be absorbed.

### Example 2

### Reduced Nutrient Leaching

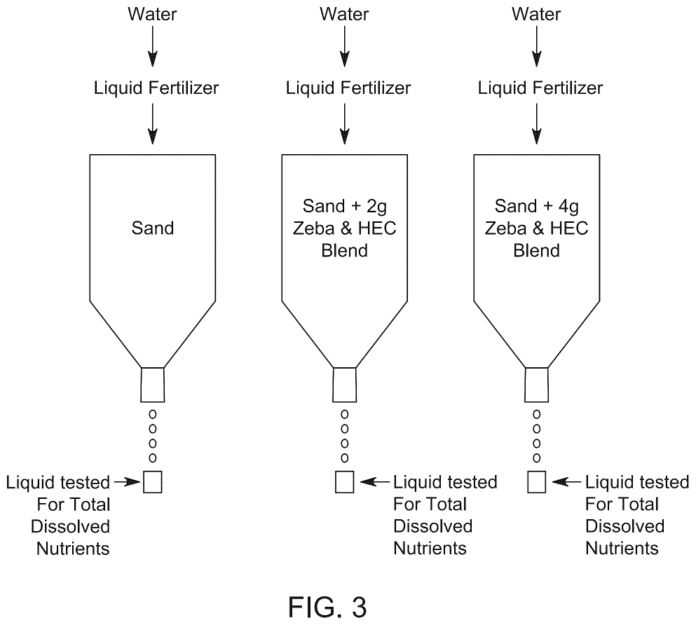

Experiments were performed in which the nutrient leaching of fertilizer from soil and soil with various combinations of added dry materials are compared. As described above in Example 1, sand was chosen for the experiments and the experiments were performed using the same ratio of superabsorbent polymer to HEC in the blend as described above. The same overall weight of dry materials were added to each container and the weight of sand was reduced in proportion to the weight of the other dry materials. For the entries that utilized Zeba and HEC, the Zeba and HEC were mixed together into a blend and then that blend was mixed with the sand. One entry utilized 2 g of this Zeba and HEC blend and the other entry utilized 4 g of this Zeba and HEC blend. The same overall amount of liquid fertilizer was added to each container. The same overall amount of water was then added to each container. The amount of liquid fertilizer and water added was enough so that leaching is observed in each container. The amount of needed liquid was determined by the previous experiment in which the amount of water needed prior to the first drop of water leaching out was observed. Each entry had 21 mL of liquid added. The liquid fertilizer used, Jackpot Fertilizer Micronutrient Mix, has instructions to add it at a rate of 1 oz of fertilizer mixed with 1 Gallon of water. This ratio was used to blend an adequate sample of fertilizer and water for all of the entries in this part of the experiment. The liquid leaching from each of the containers was captured in another empty container. The captured liquid was tested for the total dissolved nutrients using a total dissolved nutrients meter. The total dissolved nutrients in the fertilizer and water blend was 600 ppm to start with. The entries were as follows (see also FIG. 3 for a schematic of the experimental design):
Sand+Fertilizer;
Sand+Fertilizer+2 g Zeba and HEC blend; and
Sand+Fertilizer+4 g Zeba and HEC blend.

The results are shown in Table 5 below.

TABLE 5
Total Dissolved Nutrients with Superabsorbent
Polymer Zeba Blend

| | Total Dissolved Nutrients |
|---|---|
| Sand | 530 ppm |
| Sand + 2 g Zeba & HEC Blend | 434 ppm |
| Sand + 4 g Zeba & HEC Blend | 354 ppm |

The entries that contain the Zeba & HEC blend had a higher retention rate of total dissolved nutrients compared to the entry that just contained sand. This shows that the addition of this superabsorbent polymer blend aided in nutrient retention. Also, the addition of a higher rate of the superabsorbent polymer blend reduced the nutrient leaching even further.

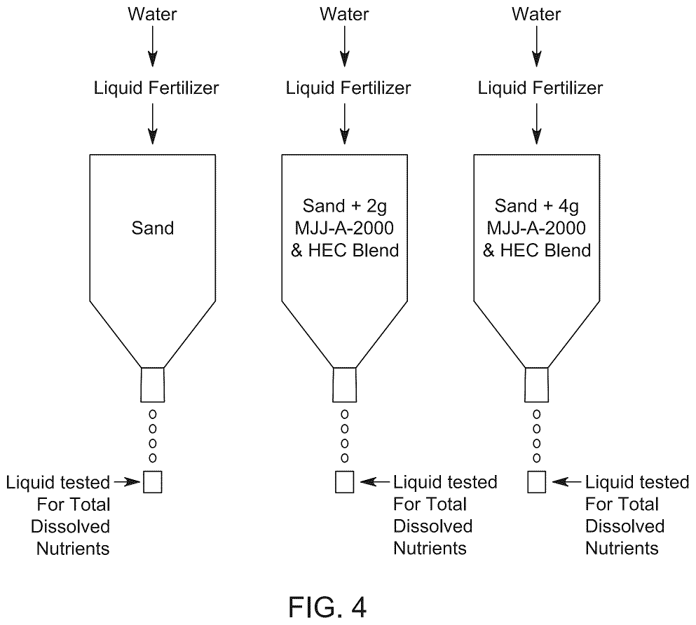

This experiment was also performed with the superabsorbent polymer MJJ-A-2000. The entries were as follows (see also FIG. 4 for a schematic of the experimental design):
Sand+Fertilizer;
Sand+Fertilizer+2 g MJJ-A-2000 and HEC blend; and
Sand+Fertilizer+4 g MJJ-A-2000 and HEC blend.

The results are shown in Table 6 below.

TABLE 6
Total Dissolved Nutrients with Superabsorbent
Polymer MJJ-A-2000 Blend

| | Total Dissolved Nutrients |
|---|---|
| Sand | 530 ppm |
| Sand + 2 g MJJ-A-2000 & HEC Blend | 424 ppm |
| Sand + 4 g MJJ-A-2000 & HEC Blend | 361 ppm |

The entries that contained the MJJ-A-2000 and HEC blend had a higher retention rate of total dissolved nutrients compared to the entry that just contained sand. This shows that the addition of this superabsorbent polymer blend aided in nutrient retention. Also, the addition of a higher percentage of the superabsorbent polymer blend to the sand substantially improved the nutrient retention capabilities. These results illustrate that the superabsorbent polymer blends can significantly reduce nutrient leaching from soil.

### Example 3

### Reduced Pesticide Leaching

Experiments were performed in which pesticide leaching from sand vs sand with various combinations of added dry materials was compared. Sand was used in the experiment and the experiment was performed using the same ratio of superabsorbent polymer to HEC in the blend as described above in Example 1. The same overall weight of dry materials were added to each container and the weight of sand was reduced by the weight of dry materials included. There was 10 mL of pesticide used in each entry. The pesticide used was Imidacloprid. For the entries that utilized Zeba and HEC, the Zeba and HEC were mixed together into a blend and then this blend was mixed with the fertilizer, pesticide, and sand. One entry utilized 0.1 g of this Zeba and HEC blend and one entry utilized 2 g of this Zeba and HEC blend. The same overall amount of water was added to each container. 30 mL of water was added. The liquid leaching was captured in another empty container. The entries were as follows:
Sand+Pesticide;
Sand+Pesticide+0.1 g Zeba & HEC Blend; and
Sand+Pesticide+2 g Zeba & HEC Blend.

The results are shown in Table 7 below.

TABLE 7
Pesticide Retention with Superabsorbent
Polymer Zeba Blend, Imidacloprid

| | mL of | |
|---|---|---|
| | liquid | Density of |
| | leeched | leeched liquid |
| Sand | 30 mL | 1.029 |
| Sand + 0.1 g Zeba & HEC Blend | 27 mL | 1.026 |
| Sand + 2 g Zeba & HEC Blend | 5 mL | 0.946 |

The entries that contained the combination of Zeba & HEC had a higher retention rate of the liquid compared to the entry that just contained sand. Additionally, the entries that utilized the superabsorbent polymer blend had a density closer to water whereas the entry that utilized just sand had a density closer to that of imidacloprid, suggesting that more of the pesticide itself leeched through the just sand entry. This shows that the addition of this superabsorbent polymer blend aided in pesticide retention. Also, the addition of a higher percentage of the superabsorbent polymer blend to the sand significantly reduced pesticide leaching.

This experiment was repeated with another superabsorbent polymer, MJJ-A-2000. The entries were as follows:
Sand+Pesticide;
Sand+Pesticide+0.1 g MJJ-A-2000 and HEC Blend; and
Sand+Pesticide+2 g MJJ-A-2000 and HEC Blend.

The results are shown in Table 8 below.

TABLE 8
Pesticide Retention with Superabsorbent
Polymer MJJ-A-2000 Blend, Imidacloprid

| | mL of | |
|---|---|---|
| | liquid | Density of |
| | leeched | leeched liquid |
| Sand | 30 mL | 1.029 |
| Sand + 0.1 g MJJ-A-2000 & HEC Blend | 26 mL | 1.026 |
| Sand + 2 g MJJ-A-2000 & HEC Blend | 10 mL | 1.007 |

The entries that contained the combination of MJJ-A-2000 & HEC had a higher retention rate of the liquid compared to the entry that just contained sand. Additionally, the entries that utilized the superabsorbent polymer blend had a density closer to water whereas the entry that utilized just sand had a density closer to that of imidacloprid, suggesting that more of the pesticide itself leeched through the just sand entry. This shows that the addition of this superabsorbent polymer blend to the sand aided in pesticide retention. Also, the addition of a higher percentage of the superabsorbent polymer blend to the sand significantly reduced pesticide leaching. These results illustrate that the superabsorbent polymer blends can significantly reduce pesticide leaching from soil.

### Example 4

### Improved Retention of Microbes

Experiments were performed in which the capability of the superabsorbent polymer blends to improve retention of microbes in the soil was tested. The experiments were performed using the same ratio of superabsorbent polymer to HEC as described above in Example 1, and the same overall weight of dry materials were added to each container. The weight of sand was reduced by the weight of the dry materials added. The amount of water added is enough so that leaching is observed in each container. 30 mL of water was added. The liquid leaching is captured in another empty container. The amount of colony forming units (CFUs) of microbes in the leached liquid captured from each entry was determined. For the entry that utilized Zeba, 2 g of Zeba was blended with the sand. For the entry that utilized HEC, 2 g of HEC was blended with the sand. For the entry that utilized a combination of the Zeba and HEC, the Zeba and HEC were mixed together and then 2 g of this mixture was blended with the sand. All entries had 0.1 g of dry fermentation solids of the microbial strain K-357 accession number NRRL B-23318 (sold by Kannar Earth Science, Ltd., Lawrenceville, GA) blended with the sand. The entries are as follows and the results are shown in Table 9 below:
Sand+K-357 microbe;
Sand+2 g Zeba and HEC Blend+K-357 microbe; and
Sand+4 g Zeba and HEC Blend+K-357 microbe.

TABLE 9
Testing for Retention of Microbes with
Superabsorbent Polymer Zeba Blend

| | CFUs in Leached Liquid |
|---|---|
| Sand | 1.57E+09 |
| Sand + 2 g Zeba & HEC Blend | 1.69E+09 |
| Sand + 4 g Zeba & HEC Blend | 5.70E+08 |

This experiment was repeated with another superabsorbent polymer, MJJ-A-2000. The entries were:
Sand+K-357 microbe;
Sand+2 g MJJ-A-2000 and HEC blend+K-357 microbe; and
Sand+4 g MJJ-A-2000 and HEC blend+K-357 microbe.

The results are shown in Table 10 below.

TABLE 10
Testing for Retention of Microbes with
Superabsorbent Polymer MJJ-A-2000 Blend

| | CFUs in Leached Liquid |
|---|---|
| Sand | 1.57E+09 |
| Sand + 2 g MJJ-A-2000 & HEC Blend | 1.14E+09 |
| Sand + 4 g MJJ-A-2000 & HEC Blend | 8.00E+08 |

The data in Tables 9 and 10 show that the entry that contained just sand as well as the entry that contained Sand+2 g of Zeba and HEC blend were not statistically different in their CFU counts. The remaining entries showed that the addition of the superabsorbent polymer and HEC blend allowed for a higher percentage of the microbial strain to be retained relative to the sand by itself. The higher the CFUs that ended up leaching out, the less of the microbial strain that was retained in the entry. These results show that the addition of the superabsorbent polymer blends can substantially reduce leaching of microbes from the soil.

### Example 5

### Increased Ability for Seedlings to Breakthrough the Crusting of the Soil

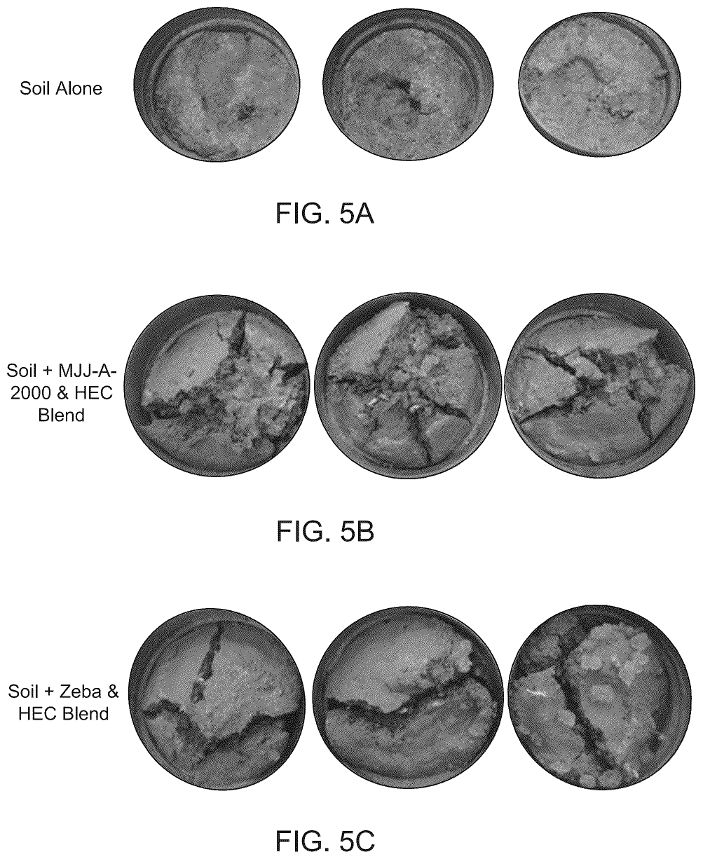

Experiments were performed in which the capability of seedlings to break through the crust of soil with various combinations of superabsorbent polymer blends were compared. The experiments were performed using the same ratio of superabsorbent polymer to HEC in the blend as described above in Example 1. One pot was filled with potting soil into which seeds are planted (10 canola seeds/pot) which served as the control. Clay soil is placed on top of this mixture. One pot is filled with a mixture of potting soil plus Zeba and HEC blend into which seeds are planted (10 canola seeds/pot). Clay soil is also placed on top of this mixture. Another entry included a mixture of potting soil plus superabsorbent polymer MJJJ-A-2000 and HEC blend and 10 canola seeds/pot were planted. In each case the weight of the potting soil was reduced by the weight of the dry blend included. For the entries that utilized a superabsorbent polymer and HEC blend, 2 g of this blend was used. All pots had clay soil filled to the neck of a 4″ pot. The canola seeds were placed 1″ depth for all entries. The seedlings' ability to breakthrough the crust of the soil was observed for all the entries and the results are illustrated in FIG. 5, three days after planting.

As shown in FIG. 5A, the potting soil alone topped with clay soil did not exhibit any cracking or seedling emergence, three days after the seed was sowed (Soil alone). In contrast, the potting soil mixed with either superabsorbent polymer blend (i.e, “Soil+MJJ-A-2000 & HEC Blend” or “Soil+Zeba & HEC Blend”) and topped with clay showed multiple canola seedlings emerging through the cracks (see FIGS. 5B and 5C, respectively). These results illustrate that addition of the superabsorbent polymer blends to soil can significantly enhance seedling ability to break through soil crust.

### Example 6

### Enhanced Nutrient Uptake

An experiment was performed in which the nutrient uptake of plants in regular potting soil mixed with fertilizer granules is compared to a mixture of regular potting soil and fertilizer granules mixed with a blend of superabsorbent polymer Zeba and HEC as described above in Example 1. The same overall weight of dry materials were added to each pot by reducing the amount of soil by the weight of the superabsorbent polymer and HEC blend that was added Peanut seeds were planted in each pot, each pot having one of the above listed compositions. The pots were then placed in the same greenhouse conditions and watered regularly with the same amount of water. The entries are as follows:
Soil+Fertilizer; and
Soil+Fertilizer+Zeba & HEC Blend.

The overall appearance of the peanut plants was noted. After 8 days without water, the entry that did not utilize the superabsorbent polymer and HEC blend showed signs of reduced nutrient and iron uptake and lack of chlorophylls. The leaves were showing signs of becoming more yellow than the entry that utilized the superabsorbent polymer and HEC blend. The entry that utilized the superabsorbent polymer and HEC blend had healthy looking leaves that were a deeper green color. After 14 days without water, nutrient deficiency, leaf chlorosis, and petiole wilting was evident in the entry that did not utilize the superabsorbent polymer and HEC blend. The entry that had the superabsorbent polymer and HEC blend showed minimal signs of chlorosis, and the leaves appeared as a deeper and healthier green color than the other entry (data not shown). Additionally, the leaves of the entry that had the superabsorbent polymer and HEC blend had minimal wilting (data not shown).

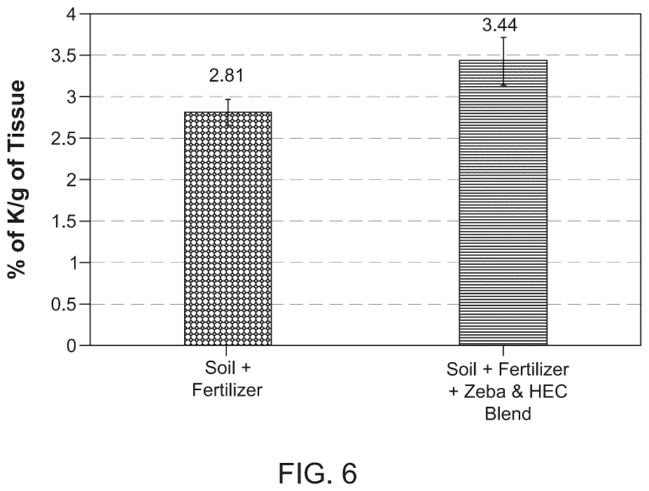

FIG. 6 shows the results for potassium uptake by the leaves of the peanut plants after 21 days of growth in the greenhouse. Specifically, there was a significant increase of potassium uptake (22.4%) by the plants grown in the potting Soil+Fertilizer+Zeba & HEC blend as compared to the plants grown without the added superabsorbent polymer blend (Soil+Fertilizer).

These results illustrate that addition of the superabsorbent polymer blends can significantly enhance seedling growth and health as well as the ability to take up potassium.

### Example 7

### Improved Moisture Retention of Plants and Seedlings in Drought Conditions

An experiment was performed in which young tomato plants were planted using differing mixtures of potting soil alone, soil plus fertilizer granules, and soil plus fertilizer granules plus superabsorbent polymer blends and then were subject to drought conditions. The superabsorbent polymer blends used were the same as described in Example 1 above. The moisture retention as well as the general appearance of the plants themselves were observed. The same overall weight of dry materials was added to each 6 inch pot, 2.484 lbs, and the weight of the potting soil was reduced by the weight of the added dry components. The same amount of water was added to each pot, 100 mL. Another 100 mL of water was added to the pots 5 days later. The pots were then left in the greenhouse and were not given more water to allow for extreme drought conditions. The weights of the pots were taken at various increments to determine the water retention of each entry. The entries that contained fertilizer had 0.066 lbs of fertilizer per pot. The entries that contained the combination of Zeba and HEC had 0.022 lbs of the combination per pot. The 0.022 lbs of the Zeba and HEC blend was added to the applicable entries by the roots, about 6″ down in the pots. The soil used was Miracle Grow potting mix. The fertilizer used was Greenview Multipurpose 10-10-10 fertilizer. The entries were as follows:
Entry 1: Soil;
Entry 2: Soil+Fertilizer mixed together;
Entry 3: Soil+Fertilizer+Zeba & HEC Blend all mixed together; and
Entry 4: Soil+Fertilizer mixed together+Zeba & HEC Blend added on top of the soil and fertilizer mixture.

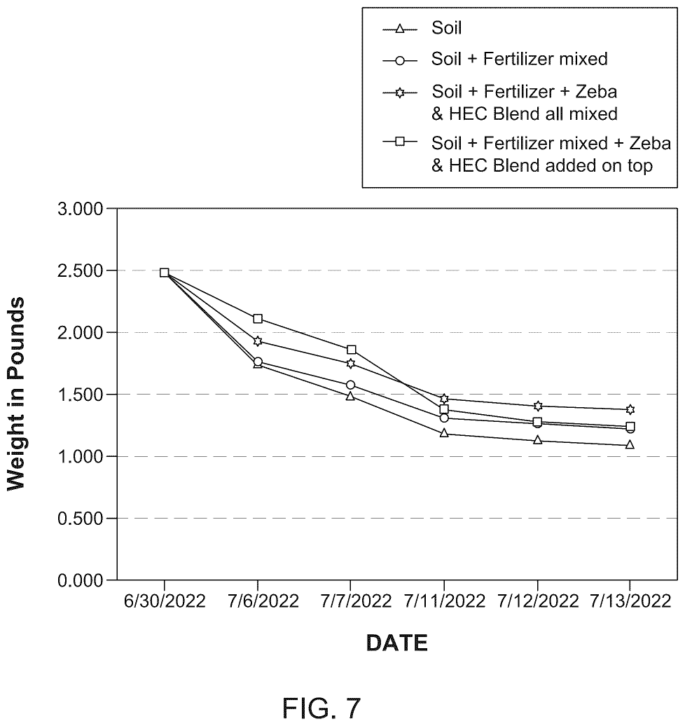

The results are shown in FIG. 7. FIG. 7 is a graph illustrating the weight change of the pots containing the tomato plants over the course of the two weeks of drought conditions. The entries that contained the Zeba and HEC blend had a higher level of water retention over time. The entry that contained the Zeba and HEC blend mixed together with the soil and fertilizer had the best water retention by the end of the two-week period. The weights observed are shown in Table 11 below.

TABLE 11
Weight Change in Pounds

| | Jun. 30, 2022 | Jul. 6, 2022 | Jul. 7, 2022 | Jul. 11, 2022 | Jul. 12, 2022 | Jul. 13, 2022 |
|---|---|---|---|---|---|---|
| Entry #1 | 2.484 | 1.754 | 1.490 | 1.189 | 1.129 | 1.093 |
| Entry #2 | 2.484 | 1.770 | 1.566 | 1.308 | 1.260 | 1.228 |
| Entry #3 | 2.484 | 1.932 | 1.746 | 1.467 | 1.408 | 1.377 |
| Entry #4 | 2.484 | 2.118 | 1.862 | 1.378 | 1.287 | 1.240 |

Regarding the general appearance of the plants after 12 days:
Entry #1 was showing signs of chlorosis and nutrient deficiency;
Entry #2 was greener than entry #1, but had some blistering/heat shock spots;
Entry #3 had leathery, dark green leaves. There was no chlorosis, but there were some blistering/heat shock spots; and
Entry #4 had leathery, dark green leaves. There was no chlorosis.

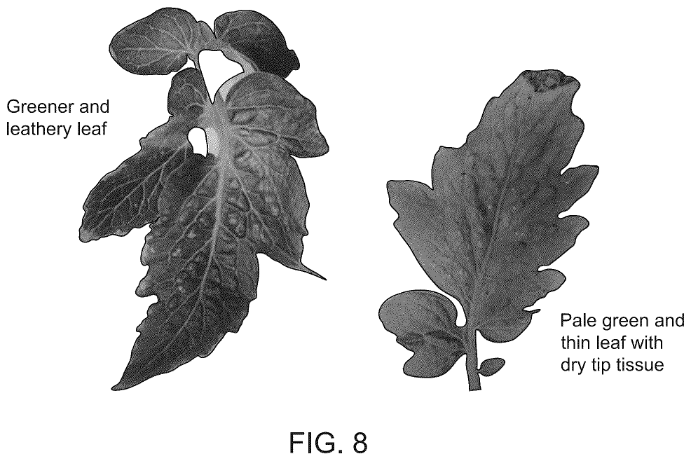

FIG. 8 shows photographs of two of the tomato leaves from the experiment after the two weeks of growth in the greenhouse without water. The leaf on the left grown in the soil+fertilizer+Zeba & HEC Blend all mixed entry is a greener and leathery leaf and the leaf on the right grown in the soil+fertilizer mixed without superabsorbent polymer blend is a smaller, pale green and thin leaf with dry tip tissue. These results illustrate that addition of the superabsorbent polymer blends can significantly enhance plant growth, health, and vigor in drought conditions.

### Example 8

### Improved Yield in Peanut Plant Field Trials

Field trials were conducted on peanuts in South Georgia in 2022. In the trials, the superabsorbent polymer blend Zeba+HEC (ratio 96.8:3.2) was utilized with each of two different standard chemical seed treatments (i.e., Rancona VPL and Syngenta) both alongside Thimet (AMVAC) and without Thimet. The entries that utilized the Zeba+HEC blend had the blend added at 2 lbs/acre in furrow. For the trials in which the superabsorbent polymer blend was used along with Thimet, the yield was increased. Specifically, when utilizing standard chemical seed treatment 1 (Rancona VPL), the yield increase was approximately a 5.3% increase in pounds of peanuts per acre. When utilizing standard chemical seed treatment 2 (Syngenta), the yield increase was approximately a 7.3% increase in pounds of peanuts per acre. The superabsorbent polymer blend Zeba+HEC did not have an impact on the yield in the entry in which it was used by itself. The results suggest that the superabsorbent polymer blend Zeba+HEC aided in the retention of the insecticide Thimet for use by the plants. In addition, the results show that inclusion of the improvement in yield.

One skilled in the art will readily appreciate that the present disclosure is well adapted to carry out the objects and obtain the ends and advantages mentioned, as well as those inherent therein. The present disclosure is representative of embodiments, which are exemplary, and are not intended as limitations on the scope of the present disclosure. Changes and other uses will occur to those skilled in the art which are encompassed within the spirit of the present disclosure as defined by the scope of the claims.

No admission is made that any reference, including any non-patent or patent document cited in this specification, constitutes prior art. It will be understood that, unless otherwise stated, reference to any document herein does not constitute an admission that any of these documents forms part of the common general knowledge in the art in the United States or in any other country. Any discussion of the references states what their authors assert, and the applicant reserves the right to challenge the accuracy and pertinence of any of the documents cited herein. All references cited herein are fully incorporated by reference, unless explicitly indicated otherwise. The present disclosure shall control in the event there are any disparities between any definitions and/or description found in the cited references.

What is claimed is:

1. A dry composition for use as a soil conditioner comprising a superabsorbent polymer and a cellulosic fiber comprising at least one of hydroxyethylcellulose or methyl cellulose.

2. The composition of claim 1, wherein the superabsorbent polymer comprises one or more of a starch-based polymer, starch-g-poly(2-propenaminde-co-2-propenoic acid), starch grafted-2-propenoic acid-2 crosslinked polymer, xanthan gum, guar gum, hydroxyethylcarboxymethylcellulose, carboxymethylcellulose, polyacrylamides, Zeolite hyaluronic acid, humic acid, Chitin/chitosan polymers, volcanic earth and ash, kelp, or sea weed.

3. The composition of claim 1, wherein the superabsorbent polymer comprises starch grafted-2-propenoic acid-2 crosslinked polymer and the cellulosic fiber comprises hydroxyethylcellulose.

4. The composition of claim 1, wherein the superabsorbent polymer comprises starch-g-poly(2-propenaminde-co-2-propenoic acid) and the cellulosic fiber comprises hydroxyethylcellulose.

5. The composition of claim 1, wherein the superabsorbent polymer and the cellulosic fiber are not covalently bonded.

6. The composition of claim 1, further comprising one or more of a nutrient, plant growth promoter, microbial agent, pesticide, antioxidant, fertilizer, or biostimulants for benefiting one or both of plant growth and health.

7. The composition of claim 6, wherein the nutrient, plant growth promoter, microbial agent, pesticide, antioxidant, fertilizer, or biostimulant comprises one or more of Bacillus licheniformis strain NRRL B-23318 (K-357), or potassium humate.

8. The composition of claim 1, wherein the ratio of the superabsorbent polymer to the cellulosic fiber ranges from about 99:1 to about 75:25, about 98:2 to about 75:25, about 97:3 to about 75:25, about 96:4 to about 75:25, about 95:5 to about 75:25, about 94:6 to about 75:25, or about 90:10 to about 75:25.

9. The composition of claim 1, wherein the ratio of the superabsorbent polymer to the cellulosic fiber ranges from about 97:3 to about 25:75.

10. The composition of claim 1, wherein the composition is formulated as granules, flakes, powders, or prills, or combinations thereof.

11. A method for improving the condition of soil comprising applying a composition to the soil, wherein the composition comprises a superabsorbent polymer and a cellulosic fiber comprising at least one of hydroxyethylcellulose and methyl cellulose.

12. The method of claim 11, wherein the superabsorbent polymer comprises one or more of a starch-based polymer, starch-g-poly(2-propenaminde-co-2-propenoic acid), starch grafted-2-propenoic acid-2 crosslinked polymer, xanthan gum, guar gum, hydroxyethylcarboxymethylcellulose, carboxymethylcellulose, polyacrylamides, Zeolite hyaluronic acid, humic acid, Chitin/chitosan polymers, volcanic earth and ash, kelp, or sea weed.

13. The method of claim 11, wherein the superabsorbent polymer comprises starch grafted-2-propenoic acid-2 crosslinked polymer and the cellulosic fiber comprises hydroxyethylcellulose.

14. The method of claim 11, wherein the superabsorbent polymer comprises starch-g-poly(2-propenaminde-co-2-propenoic acid) and the cellulosic fiber comprises hydroxyethylcellulose.

15. The method of claim 11, wherein the composition further comprises one or a combination of a nutrient, plant growth promoter, microbial agent, pesticide, antioxidant, fertilizer, or biostimulant for benefiting one or both of plant growth and health.

16. The method of claim 15, wherein the nutrient, plant growth promoter, microbial agent, pesticide, antioxidant, fertilizer, or biostimulant comprises one or more of Bacillus licheniformis strain NRRL B-23318 (K-357), or potassium humate.

17. The method of claim 11, wherein applying the composition to soil comprises depositing the composition on top of soil, mixing the composition with soil or applying the composition deep into soil.

18. The method of claim 17, wherein mixing the composition with soil comprises mixing at a rate of about 0.5 to about 4 pounds per acre or about 1 to about 3 pounds per acre.

19. The method of claim 17, wherein applying the composition deep into soil comprises applying into soil at a rate ranging from about 8 to about 12 pounds per acre.

20. The method of claim 11, wherein the ratio of the superabsorbent polymer to the cellulosic fiber in the composition ranges from about 99:1 to about 75:25, about 98:2 to about 75:25, about 97:3 to about 75:25, about 96:4 to about 75:25, about 95:5 to about 75:25, about 94:6 to about 75:25, or about 90:10 to about 75:25.
